(19) United States
(12) Patent Application Publication
(10) Pub. No.: US 2017/0057268 A1
(43) Pub. Date: Mar. 2, 2017

(54) Process for Producing Printed Wooden Plaques and Trophies

(71) Applicant: Jerry Surber, Madisonville, TX (US)

(72) Inventor: Jerry Surber, Madisonville, TX (US)

(21) Appl. No.: 15/015,256

(22) Filed: Feb. 4, 2016

Related U.S. Application Data
(60) Provisional application No. 62/213,023, filed on Sep. 1, 2015.

(51) Int. Cl. B41M 5/00; B41J 2/01; A47G 33/00; B41M 5/382

(52) U.S. Cl. CPC B41M 5/0047; B41M 5/0076; B41M 5/382; B41J 2/01; A47G 33/004

(57) ABSTRACT

A process for printing the surface of wooden trophies by cutting wooden sheet(s) or block(s) to desired shape to provide pieces with surface(s) and edges; laminating at least one surface of the cut pieced with heat transfer foil to provide a shade of white coating; and printing a design onto the shade of white coating on the surface of the piece by UV printing or sublimation printing and trophies so made.

### CROSS-REFERENCE TO RELATED APPLICATION

This application claims the benefit and priority from U.S. Provisional Patent Application 62/213023 filed Sep. 1, 2015, the contents and disclosure of which is incorporated herein by reference for all purposes.

### BACKGROUND

Field of the invention

The invention pertains to manufacture and printing of wooden plagues and trophies.

Background

Wooden trophies typically are not printed. Graphics and other information is printed on separate sheets or metal plates and attached to the wooded trophy by adhesive. This make the trophies and plaques relatively expensive, necessarily relatively small, not easily adaptable to customization in small batches and lacking in the aesthetic appearance of graphics printed directly on the trophy or plaque surface. Thus, most made in China hand painted trophies are made of polymer resin material in cold casting process. These lack the quality look and feel of wooden trophies and plaques.

What is needed is an inexpensive easily customizable, means to provide quality wooden trophies and plaques that have graphics and information directly printed on the wooded surface. The present invention is such a means.

### BRIEF SUMMARY OF THE INVENTION

The invention is, therefore, a process for printing the surface of wooden trophies comprising:
a) cutting wooden sheet(s) or block(s) to desired shape to provide pieces with surface(s) and edges;
b) laminating at least one surface of the cut pieced with heat transfer foil to provide a shade of white coating;
c) printing a design onto the shade of white coating on the surface of the piece by UV printing or sublimation printing.

It is also trophies and plaques made by the process.

### BRIEF DESCRIPTION OF THE DRAWINGS

FIG. 1 is a flow diagram of the process an embodiment of the invention.

FIGS. 2A, 2B and 2C are illustrations of wooden trophies made by an embodiment of the invention.

FIG. 3 is an illustration of large wooden plaques made by an embodiment of the invention.

FIG. 4 is an illustration of a stacked trophy with wooded risers.

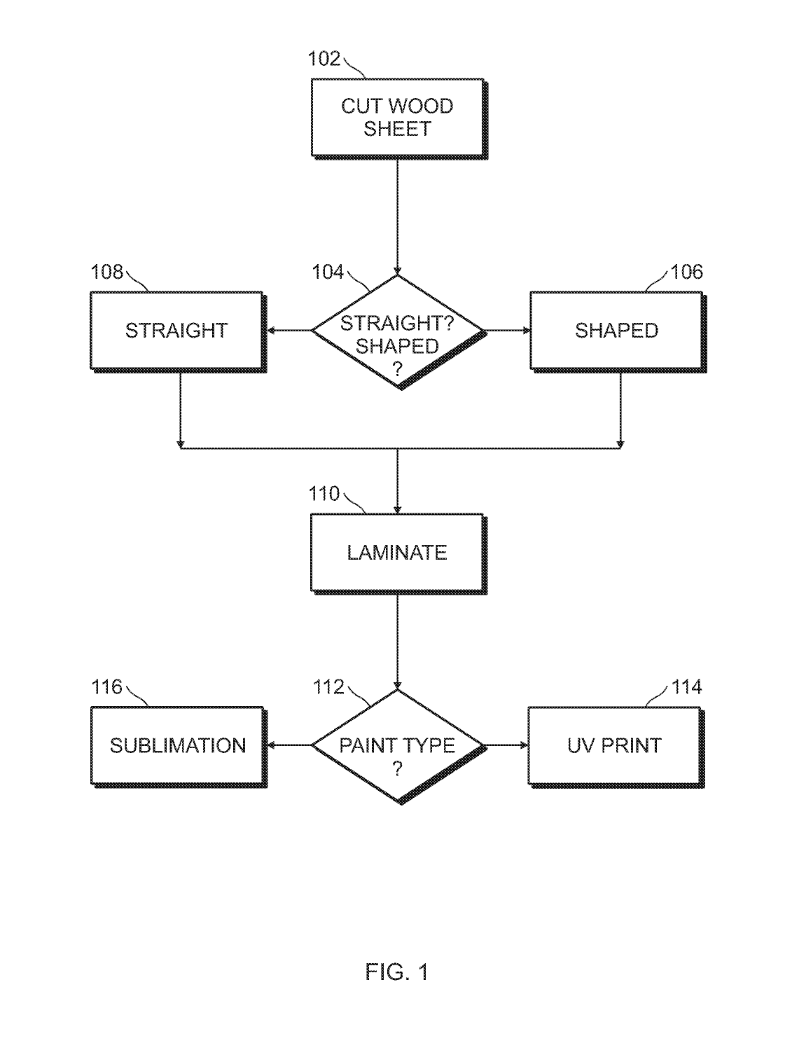

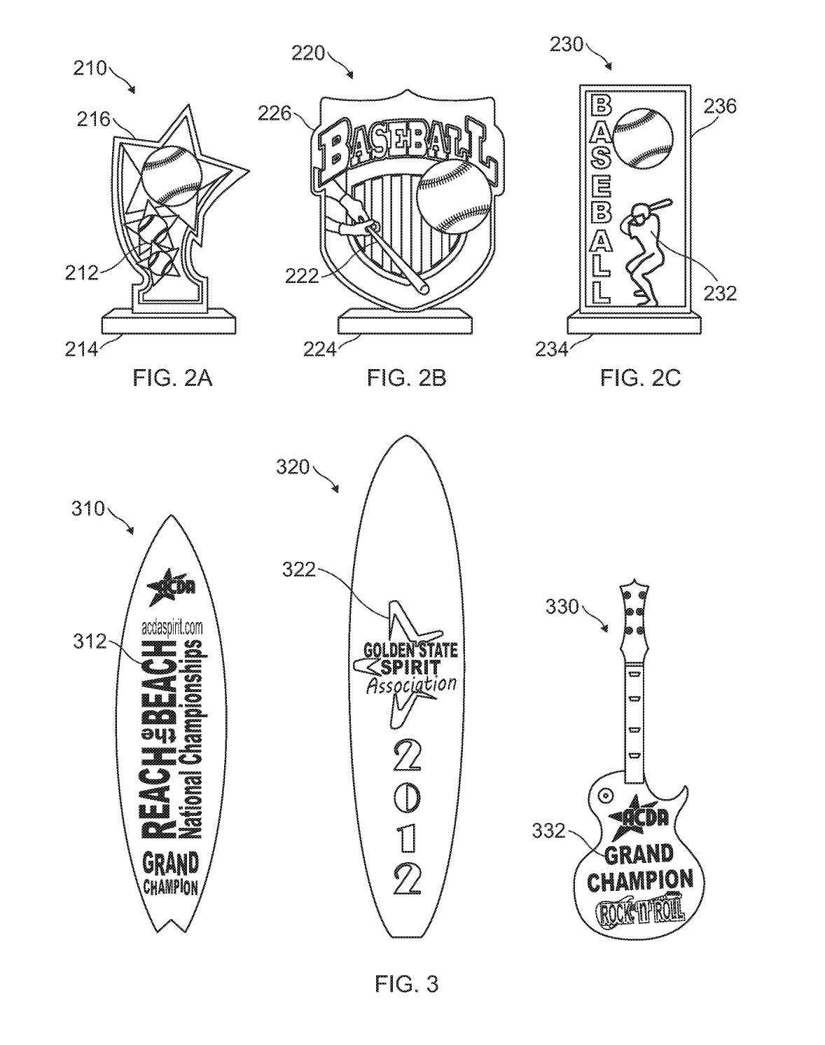

### DETAILED DESCRIPTION

[0011]Referring to FIG. 1, flat wooden stock or medium density fiberboard (MDF) sheet stock is cut into pieces (102). While many hardwoods are suitable for use in the process of the invention MDF a customary material for trophies and plaques and is preferred. MDF is especially suitable as it is relatively inexpensive, dimensionally stable, and has a very consistent surface for printing. See article at en.wikipedia.org/wiki/Medium-density_fibreboard. Plaques and flat trophies are generally made from ½ inch to one inch thick sheet with ⅜ inch thickness being most common. Blocks of MDF (or other wood) can also be used to make three dimensional (block) trophies by the same process. After cutting the sheet(s) (or block) to the desired shape, it is determined (104) if the finished piece is to be straight edged (as illustrated in FIG. 2C, lead line 236) or shaped (as illustrated in FIGS. 2A and 2B, lead lines 216 and 226). If shaped then the edges are painted (108) and if straight the edges can be laminated (106) is the same manner as the surface is laminated (110) as described below. Painting the edges requires them to be painted, sanded, repainted, sanded and repainted until a suitably smooth finish is achieved. This is much more time consuming and expensive than laminating with heat transfer foil (film) that will provide a smooth finish suitable further printing in a single step and at less cost. For painting it is preferred to use an oil based lacquer such as Black Lacquer Sealer available from Gemini Coating, Inc. (information available at www.gemini-coatings.com). Black is the preferred and customary color used on edges of plaques and trophies but any color is within the scope of the process of the invention. Block trophies may have at least one printed side surface (on white coating) and other side in any other color or pattern.

Shaped pieces are suitably made to desired shape using a computer navigated control router (CNC). Such routers are well known and widely commercially available.

The surface of the pieces (optionally with the edges finished) are then laminated with heat transfer foil (110). Suitable laminating machines are commercially available. These machines are hot roll laminators that bonds pre-glued papers, transfer foils, and other heat sensitive materials onto substrates such as particleboard, MDF, other sheet stock, or other webs of material. Rollers or a rubber conveyor belt carries the substrate into the machine and under the nip of each roller where heat and pressure securely bond the laminate. Machine with silicone roller are preferred for the process of this invention. Machines sold by Fletcher Machine Industries, Inc. of Lexington, N.C. are used successfully. As discussed above finishing with heat transfer foil (film) provides a better surface finish than paining and is much more cost effective. The surface is laminated on a laminating machine that applies heat (typically about 300° F.) and elastomer (usually silicone) rollers that applies the heat transfer surface coat (customarily a graphic such as a wood grain, marble background). In the process of the invention the coat that is transferred to the surface of the piece is white or near white (shaded of white). This is unlike the customary coating in the industry that uses laminating coating to apply background patterns to the surface of the piece (patterns such as a wood grain look, a marble look and the like). The use of a white or shade of white, while unknown in the industry, provides a much better base on which to print a suitable customer specific graphic in the next step (114 or 116) of the process. “Shades of white are colors that differ only slightly from pure white. Variations of white include what are commonly termed off-white colors, which may be considered part of a neutral color scheme .Colors often considered “shades of white” include, cream, eggshell, ivory, Navajo white, and vanilla. Even the lighting of a room, however, can cause a pure white to be perceived as off-white.” See en.wikipedia.org/wiki/Shades_of_white. A patterned or colored base coating would not be suitable for printing according to the process of the invention.

With the surface coated white or near white the piece is the printed by UV printing (114) or sublimation printing (116). Blocks of wood to make three dimensional block trophies are made in the same manner and the surface of the edges can also be printed. With UV printing slightly three dimensional (textured or sculptured) of up to about 4 mm differentiation (top of surface to bottom of pattern). Moreover, it allow production of much larger plaques and trophies than conventional means. FIG. 3 illustrates larger plaques (310,320 and 330 with printed designs 312, 322 and 330) made by the process. The skate board plaque (310 in FIG. 3A) as shown is about 42 inches high and the guitar plaque (330 in FIG. 3C) about 36″. This process provides a unique, much brighter and better defined print that can be easily adapted to small runs of pieces and thus customized to individual customer. Thus, the process of the invention provides a better, more flexible and cost effective for the manufacture of printed wood plaques and trophies.

As used herein trophies means structures used recognition for participation or achievement in an event as well as wooden sculptures for and include tangible structures having at least one relatively flat surface suitable for printing. Plagues as used herein means relatively flat wooden structures that are relatively thin (for example about ¼ to 2 inch thickness) that have at least one surface that can be printed and include award plaques, placards, signboards, decorative wall decorations and the like.

“Flatbed UV Digital printing is the reproduction of digital images using inkjet printing, typically on plastic or paperboard, although a wide variety of materials can be printed (common, photographic paper, film, cloth, plastic, etc.). Flatbed digital printers use inks made of acrylic monomers that are then exposed to strong UV-light to cure, or polymerize them . . . Environmentally, flatbed UV digital printing is based on a more sustainable system than its commercial predecessor of solvent printing as it produces fewer waste cartridges and less indoor air pollution.” See article in wikipedia at en.wikipedia.org/wiki/Flatbed_digital_printer.

UV printing allows computer generated designs to be printed thus making small number and customized trophies or plaques very economical. Sublimation printing or “Dye-sublimation printing is a digital printing technology using full color artwork that works with polyester and polymer-coated substrates. . . . Dye-sublimation printing is a digital printing technology using full color artwork that works with polyester and polymer-coated substrates . . . The end result of the sublimation process is a nearly permanent, high resolution, full color print. Because the dyes are infused into the substrate at the molecular level, rather than applied at a topical level (such as with screen printing and direct to garment printing), the prints will not crack, fade or peel from the substrate under normal conditions.” See article in wikipedia at en.wikipedia.org/wiki/Dye-sublimation_printer.

In other embodiments the invention is trophies and plaques made by the process as described above.

Trophies made from blocks of wood or MDF may be printed on one or more side surfaces and may have a design printed (212, 222 and 232 in FIGS. 2A,2B and 2C) on one surface and laminated coating of any color or pattern on other side surfaces. The shape and ornamentation (printed) of prototype trophies made by the process of the invention are illustrated in FIGS. 2A, 2B and 2C. All three were made from ⅜ inch MDF, cut to shape and laminated to provide a white surface coating. The designs as shown were then printed on the white surface by UV printing. The shape (216, 226 and 236) will determine it the sides may be printed. For example the trophies in FIG. 2A and 2B would be difficult to print the sides but the trophy in FIG. 2C could be printed on the side. The trophies may be mounted on suitable bases (214, 224 and 234) that allow them to stand upright.

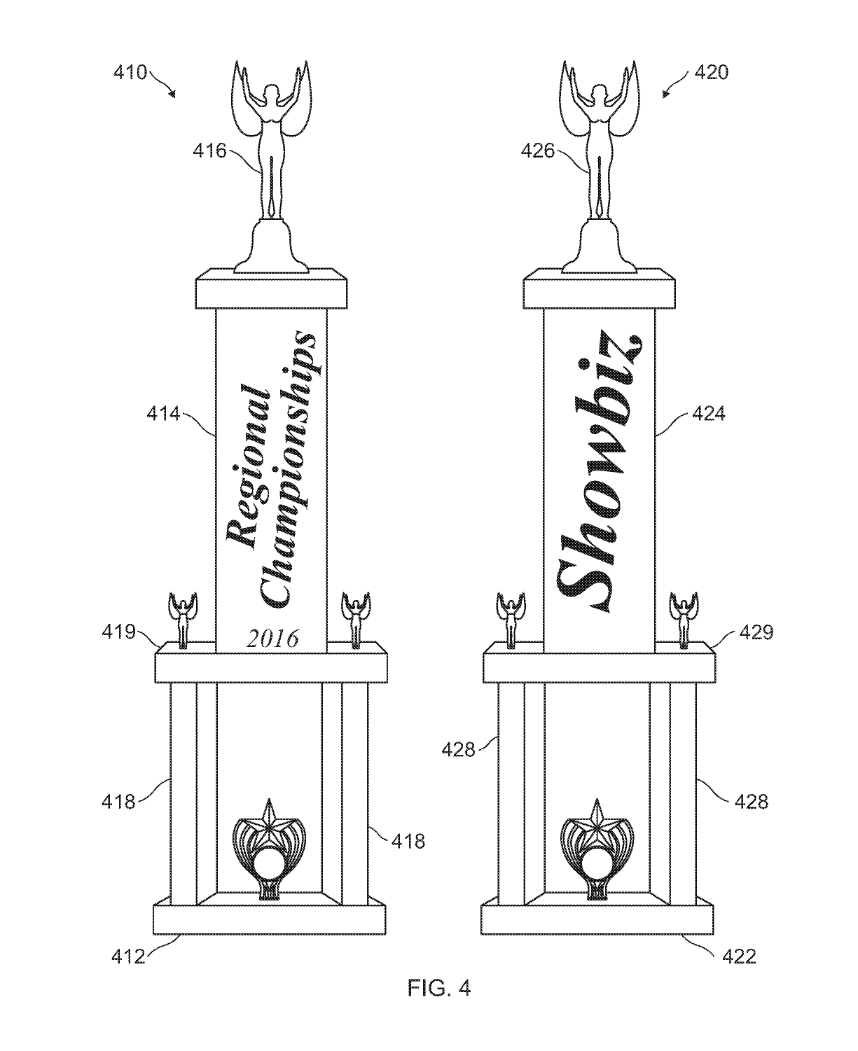

Trophies may be shaped in any manner so long as there is one surface that is printable according to the process of the invention. For example, they may have a shaped top section, shaped sides and/or back. In general block trophies will have a greater ratio of side width to front (or rear) width than plaques. For example a block trophy will generally have a front surface of at least two (2) inch width and a side of at least about 1 inch. For blocks with wider front surfaces the side will generally be at least about one quarter (¼) the width of the front. Block trophies may have a base (wood or marble is preferred—412 and 422 in FIG. 4), a lid (wood or marble preferred) and may also have a figurine or a riser and figurine attached to the top. FIG. 4 illustrates trophies with a marble base (412, 422), two wooden risers 418,428), a lid (419,429) and an additional larger printed riser (414,424) with a marble lid and a figurine (416,426) on top. The wooden riser(s) (414, 424) are printed according to the process of the invention.

In the foregoing specification, the invention has been described with reference to specific embodiments thereof. It will, however, be evident that various modifications and changes can be made thereto without departing from the broader spirit and scope of the invention as set forth in the appended claims. The specification and drawings are, accordingly, to be regarded in an illustrative rather than a restrictive sense. Therefore, the scope of the invention should be limited only by the appended claims.

1. A process for printing the surface of wooden trophies comprising:
a) cutting wooden sheet(s) or block(s) to desired shape to provide pieces with surface(s) and edges;
b) laminating at least one surface of the cut pieced with heat transfer f foil to provide a shade of white coating;
c) printing a design onto the shade of white coating on the surface of the piece by UV printing or sublimation printing.

2. The process of claim 1 wherein the edges of the cut pieces are laminated with a heat transfer foil coating or painted.

3. The process of claim 1 wherein the wooden sheet is MDF.

4. The process of claim 1 wherein the wooden sheet is from about ½ to 1 inch thickness.

5. The process of claim 1 wherein the surface of the piece to be printed is sculptured in a design pattern with depth differentiation of the sculpture of no more than 4 mm.

6. The process of claim 1 wherein the wherein the wooden sheet is MDF from about ½ to 1 inch thickness and the edges of the cut pieces are laminated with a heat transfer foil coating or painted.

7. A wooden trophy or plaque produced by:
a) cutting wood sheets or blocks to desired shape to provide pieces with surface(s) and edges;
b) laminating at least one surface of the cut pieced with heat transfer f foil to provide a shade of white coating;
c) printing a design onto the shade of white coating on the surface of the piece by UV printing or sublimation printing.

8. The trophy or plaques of claim 7 wherein the wooden(s) sheet is MDF.

9. The trophy or plaques of claim 7 the wooden sheet is from about ½ to 1 inch thickness.

10. The trophy or plaques of claim 7 the wooden piece is a block of MDF.

11. The trophy or plaques of claim 7 mounted on a base.

12. The trophy or plaques of claim 7 wherein the surface of the piece to be printed is sculptured in a design pattern with depth differentiation of the sculpture of no more than 4 mm.
